(19) United States
(12) Patent Application Publication
(10) Pub. No.: US 2023/0009433 A1
(43) Pub. Date: Jan. 12, 2023

(54) INFORMATION PROCESSING DEVICE, INFORMATION PROCESSING METHOD, AND TERMINAL DEVICE

(71) Applicant: TOYOTA JIDOSHA KABUSHIKI KAISHA, Toyota-shi (JP)

(72) Inventors: Shin SAKURADA, Toyota-shi (JP); Kazuya NISHIMURA, Anjo-shi (JP); Yuko Mizuno, Nagoya-shi (JP)

(21) Appl. No.: 17/661,833

(22) Filed: May 3, 2022

(30) Foreign Application Priority Data
Jul. 8, 2021 (JP) 2021-113859

(51) Int. Cl. A61G 5/04

(52) U.S. Cl. CPC A61G 5/04; A61G 2203/20; A61G 2203/22

(57) ABSTRACT

An information processing device includes a control unit that determines a travel path of a wheelchair that crosses a road. The control unit determines the travel path of the wheelchair based on information on undulations of a road surface of the road.

### CROSS-REFERENCE TO RELATED APPLICATION

This application claims priority to Japanese Patent Application No. 2021-113859 filed on Jul. 8, 2021, incorporated herein by reference in its entirety.

### BACKGROUND

### 1. Technical Field

The present disclosure relates to an information processing device, an information processing method, and a terminal device.

### 2. Description of Related Art

Conventionally, there is known a configuration that notifies, when a pedestrian starts crossing a desired place on a road, the surrounding vehicles that there is a pedestrian crossing the place (see, for example, Japanese Unexamined Patent Application Publication No. 2014-225151 (JP 2014-225151 A).

### SUMMARY

When crossing a road with a wheelchair, it may be difficult for the wheelchair to travel depending on the road conditions. It is required to make wheelchairs easier to travel when the wheelchair crosses the road.

An object of the present disclosure made in view of such circumstances is to improve the convenience in traveling of the wheelchair.

An information processing device according to an embodiment of the present disclosure includes a control unit that determines a travel path of a wheelchair that crosses a road. The control unit determines the travel path of the wheelchair based on information on undulations of a road surface of the road.

An information processing method according to the embodiment of the present disclosure includes determining a travel path of a wheelchair that crosses a road. The information processing method includes determining the travel path of the wheelchair based on information on undulations of a road surface of the road.

A terminal device according to the embodiment of the present disclosure is mounted on a wheelchair that crosses a road or carried by a user of the wheelchair. The terminal device acquires from an information processing device a travel path of the wheelchair that is determined by the information processing device based on information on undulations of a road surface of the road.

According to the information processing device, the information processing method, and the terminal device according to the embodiment of the present disclosure, the convenience of traveling in a wheelchair can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration example of an information processing system according to an embodiment;

FIG. 2 is a diagram showing an example of a travel path of a wheelchair determined based on contour lines of a road surface;

FIG. 3 is a diagram showing an example of a travel path of the wheelchair determined based on contour lines of the road surface and an example of a pedestrian crossing displayed along the travel path;

FIG. 4 is a front view showing an example of a position of a center of gravity of the wheelchair;

FIG. 5 is a side view showing an example of the position of the center of gravity of the wheelchair; and

FIG. 6 is a flowchart showing a procedure example of an information processing method according to the embodiment.

### DETAILED DESCRIPTION OF EMBODIMENTS

Configuration Example of Information Processing System 1

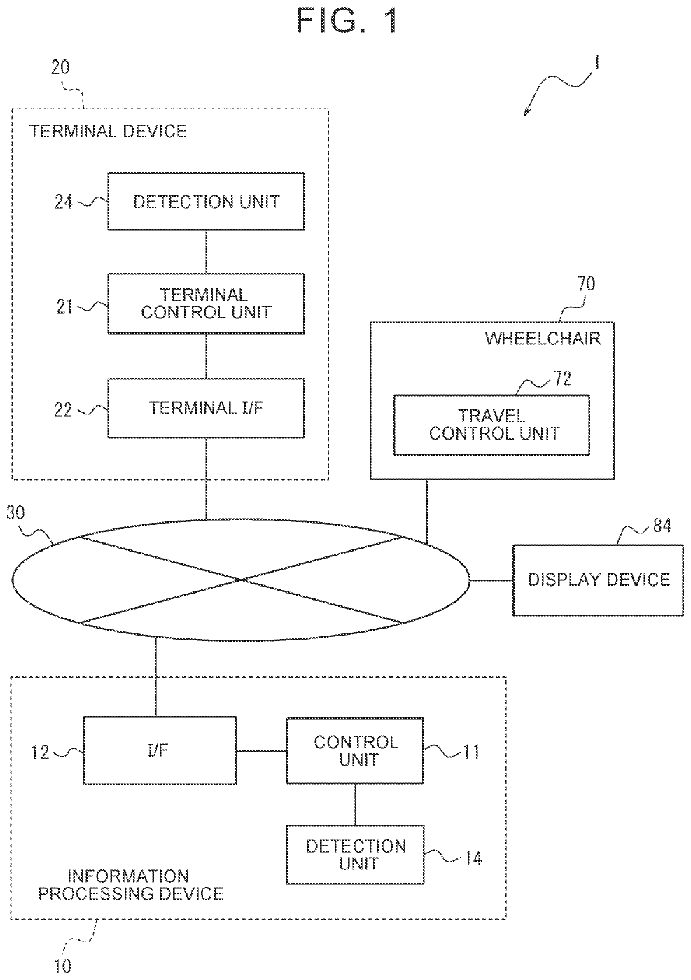

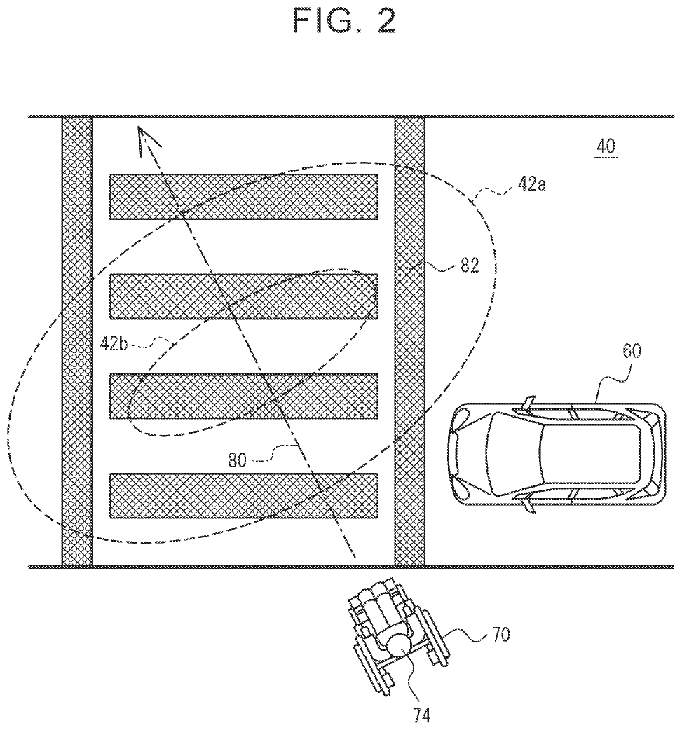

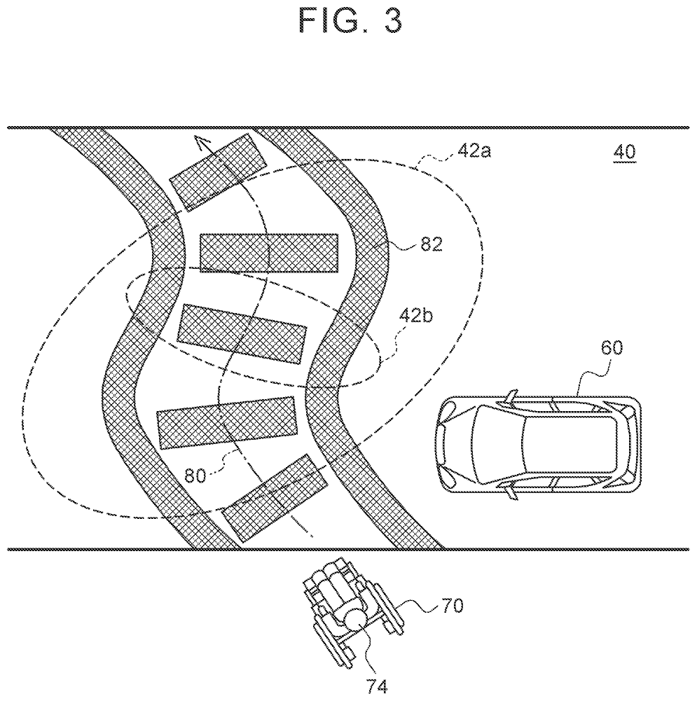

As shown in FIG. 1, an information processing system 1 according to an embodiment includes an information processing device 10 and a terminal device 20. The information processing device 10 determines a travel path 80 of a wheelchair 70 that crosses a road 40, as illustrated in FIGS. 2 and 3. The information processing device 10 determines the travel path 80 of the wheelchair 70 based on information on the undulations of the road surface of the road 40. The information processing device 10 notifies the wheelchair 70 or a user 74 of the wheelchair 70 of the determined travel path 80 using the terminal device 20. The terminal device 20 may be mounted on the wheelchair 70. The terminal device 20 may be carried by the user 74. The terminal device 20 acquires the travel path 80 of the wheelchair 70 from the information processing device 10, notifies the user 74 of the travel path 80, and controls the wheelchair 70 to travel along the travel path 80. The information processing system 1 further includes a display device 84, although not essential. The display device 84 may be configured to display the travel path 80 of the wheelchair 70 on the road 40. The display device 84 may be configured to display a pedestrian crossing 82 on the road 40 on which a vehicle 60 travels. Hereinafter, a configuration example of the information processing system 1 will be described.

Information Processing Device 10

The information processing device 10 includes a control unit 11 and a server interface 12. The server interface 12 is also referred to as an I/F 12.

The control unit 11 controls each component of the information processing device 10. The control unit 11 may be configured to include one or more processors. According to the present embodiment, the “processor” is a general-purpose processor, a dedicated processor specialized for specific processing, or the like. However, the processor is not limited thereto. The control unit 11 may be configured to include one or more dedicated circuits. The dedicated circuit may include, for example, a field-programmable gate array (FPGA) or an application-specific integrated circuit (ASIC). The control unit 11 may be configured to include the dedicated circuit instead of the processor, or may be configured to include the dedicated circuit together with the processor.

The information processing device 10 may further include a storage unit. The storage unit is, for example, a semiconductor memory, a magnetic memory, or an optical memory. However, the storage unit is not limited to these memories. The storage unit may function as, for example, a main storage device, an auxiliary storage device, or a cache memory. The storage unit may include an electromagnetic storage medium such as a magnetic disk. The storage unit stores any information used for the operation of the information processing device 10. The storage unit may store, for example, a system program, an application program, or the like. The storage unit may be included in the control unit 11.

The I/F 12 outputs information, data, or the like from the control unit 11, and inputs information, data, or the like to the control unit 11. The I/F 12 is also simply referred to as an interface or an I/F.

The I/F 12 may include a communication module configured to be communicable with the display device 84 or the like via a network 30. The communication module may include a communication module corresponding to mobile communication standards such as the fourth generation (4G) or the fifth generation (5G). However, the communication module is not limited to this. The I/F 12 may be configured to be connectable to the communication module.

The information processing device 10 may include one server device or a plurality of server devices that can communicate with each other.

The information processing device 10 further includes a detection unit 14, although not essential. The detection unit 14 detects information on the undulations of the road surface of the road 40 to be crossed by the wheelchair 70. The information on the undulations of the road surface of the road 40 is also referred to as undulation information. The undulation information may include, for example, information that specifies the height of each point on the road surface of the road 40. The undulation information may include information that specifies a slope existing on the road surface of the road 40. The undulation information may include information representing contour lines of the road surface of the road 40.

The detection unit 14 may be configured to include, for example, a camera that photographs the road surface of the road 40. The detection unit 14 may be configured to include a distance sensor that detects the distance to each point on the road surface of the road 40. The detection unit 14 may calculate the coordinates or the height of each point on the road surface of the road 40 as the undulation information based on the detected information on the road surface. The detection unit 14 may generate information specifying a slope existing on the road surface of the road 40 as the undulation information based on the detected information on the road surface. The detection unit 14 may generate information representing the contour lines of the road surface of the road 40 as the undulation information based on the detected information on the road surface.

The detection unit 14 may output the undulation information to the control unit 11. The detection unit 14 may output the detected information to the control unit 11. The control unit 11 may calculate the coordinates or the height of each point on the road surface of the road 40 as the undulation information based on the information on the road surface detected by the detection unit 14. The control unit 11 may generate information specifying a slope existing on the road surface of the road 40 as the undulation information based on the information on the road surface detected by the detection unit 14. The control unit 11 may generate information representing the contour lines of the road surface of the road 40 as the undulation information based on the information on the road surface detected by the detection unit 14.

Terminal Device 20

As shown in FIG. 1, the terminal device 20 includes a terminal control unit 21 and a terminal interface 22. The terminal interface 22 is also referred to as a terminal I/F 22.

The terminal control unit 21 controls each component of the terminal device 20. The terminal control unit 21 may be configured to be the same as or similar to the control unit 11 of the information processing device 10. The terminal control unit 21 may be configured to include one or more processors. The terminal control unit 21 may be configured to include one or more dedicated circuits. The dedicated circuit may include, for example, an FPGA or an ASIC. The terminal control unit 21 may be configured to include the dedicated circuit instead of the processor, or may be configured to include the dedicated circuit together with the processor.

The terminal device 20 may further include a storage unit. The storage unit of the terminal device 20 may be configured to be the same as or similar to the storage unit of the information processing device 10. The storage unit is, for example, a semiconductor memory, a magnetic memory, or an optical memory. However, the storage unit is not limited to these memories. The storage unit may function as, for example, a main storage device, an auxiliary storage device, or a cache memory. The storage unit may include an electromagnetic storage medium such as a magnetic disk. The storage unit stores any information that is used for the operation of the terminal device 20. The storage unit may store, for example, a system program, an application program, or the like. The storage unit may be included in the terminal control unit 21.

The terminal I/F 22 transmits to the information processing device 10 information, data, or the like output from the terminal control unit 21. The terminal I/F 22 may include a communication module configured to be communicable with other devices such as the information processing device 10 via the network 30. The communication module may include a communication module conforming to mobile communication standards such as the 4G or the 5G. However, the communication module is not limited thereto.

The terminal I/F 22 may be configured to include an input device that receives an input of information, data, or the like from the user. The input device may be configured to include, for example, a touch panel or a touch sensor, or a pointing device such as a mouse. The input device may be configured to include a physical key. The input device may be configured to include a voice input device such as a microphone.

The terminal I/F 22 may include, for example, a display device that outputs visual information such as images, characters, or figures to the user. The display device may be configured to include, for example, a liquid crystal display (LCD), an organic electro-luminescence (EL) display or an inorganic EL display, a plasma display panel (PDP), or the like. The display device is not limited to the displays above, and may be configured to include various other types of displays. The display device may be configured to include a light emitting element such as a light emitting diode (LED) or a laser diode (LD). The display device may be configured to include various other devices.

The terminal device 20 further includes a detection unit 24 that detects the undulation information of the road surface of the road 40, although not essential. The detection unit 24 may be configured to be the same as or similar to the detection unit 14 of the information processing device 10. The terminal device 20 may output the undulation information to the information processing device 10. The detection unit 24 may detect information such as an image of the road surface or a distance to each point on the road surface as information for generating the undulation information, and output the information to the information processing device 10.

The terminal device 20 may further include a position information acquisition unit that acquires the position information of the terminal device 20 itself. The position information acquisition unit may be configured to include a receiver for a satellite positioning system. The receiver compatible with the satellite positioning system may include, for example, a global positioning system (GPS) receiver.

The terminal device 20 may be mounted on the wheelchair 70 or may be carried by the user 74 of the wheelchair 70. When the terminal device 20 is mounted on the wheelchair 70, the terminal device 20 may notify the user 74 of the travel path 80 of the wheelchair 70 or may control the traveling of the wheelchair 70. When the terminal device 20 is carried by the user 74, the terminal device 20 may notify the user 74 of the travel path 80 of the wheelchair 70.

The number of the terminal devices 20 included in the information processing system 1 is not limited to one, and may be two or more. The terminal device 20 may be configured to include a mobile terminal such as a smartphone or a tablet, or a personal computer (PC) such as a laptop PC or a tablet PC. The terminal device 20 is not limited to the examples above, and may be configured to include various devices.

Display Device 84

The display device 84 may be configured to include one or more processors. The display device 84 may be configured to include one or more dedicated circuits. The display device 84 may be configured to include a storage unit. The storage unit of the display device 84 may be configured to be the same as or similar to the storage unit of the information processing device 10. The storage unit stores any information used for the operation of the display device 84. The storage unit may store, for example, a system program, an application program, or the like.

The display device 84 may be configured to include an interface for acquiring information, data, or the like from the information processing device 10. The interface may be configured to be the same as or similar to the I/F 12 of the information processing device 10.

The display device 84 is configured to include a display device for displaying the pedestrian crossing 82 on the road surface of the road 40. The display device may be configured to include light sources installed so as to be embedded in the road surface of the road 40, for example. The light source may be configured to include, for example, a light emitting element such as an LED or an LD. The light source may be configured to include, for example, a light bulb or a fluorescent lamp. The display device may be configured to project an image of the pedestrian crossing 82 onto the road surface of the road 40, for example.

The number of the display devices 84 included in the information processing system 1 is not limited to one, and may be two or more.

When the information processing system 1 detects a wheelchair 70 that crosses the road 40, the display device 84 may display the pedestrian crossing 82 on the road 40. When the information processing device 10 detects a wheelchair 70 located within a predetermined distance from the road 40 or a wheelchair 70 staying within a predetermined distance from the road 40 for a predetermined time or more, the information processing device 10 may cause the display device 84 to display the pedestrian crossing 82 so that the wheelchair 70 can cross the road 40.

The information processing system 1 may include a sensor that can detect the presence of the wheelchair 70 such as a camera or a motion sensor as a configuration for detecting the wheelchair 70 located within a predetermined distance from the road 40. The display device 84 may be configured to be able to detect the presence of the wheelchair 70 by being installed in the vicinity of the road 40. The information processing device 10 or the display device 84 may detect the wheelchair 70 located within a predetermined distance from the road 40 by acquiring the position information of the terminal device 20 from the terminal device 20 mounted on the wheelchair 70 or the terminal device 20 carried by the user 74 of the wheelchair 70.

Wheelchair 70

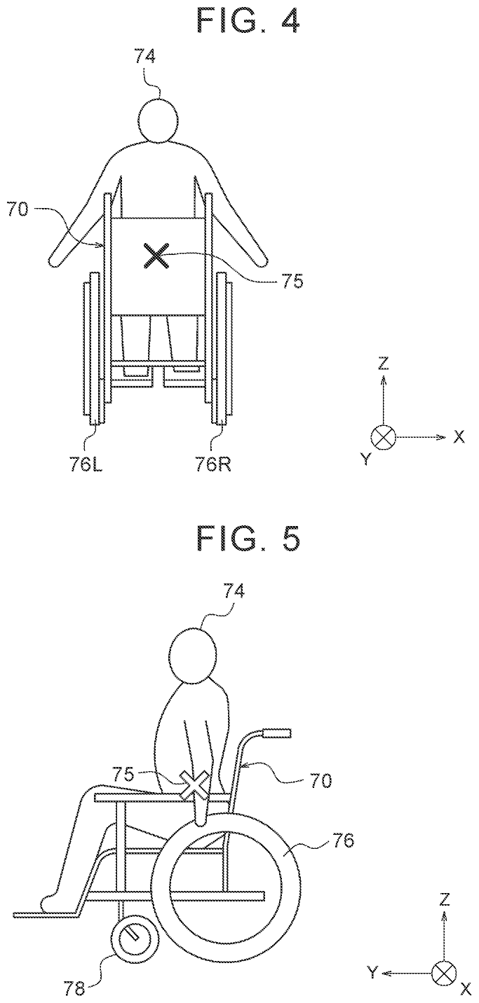

The wheelchair 70 may or may not be included in the information processing system 1. The wheelchair 70 includes drive wheels 76 and casters 78, as shown in FIGS. 4 and 5. The drive wheels 76 include a left drive wheel 76L and a right drive wheel 76R. When the user 74 is seated on the wheelchair 70, the position of the center of gravity of both the wheelchair 70 and the user 74 is represented as a center of gravity position 75.

As shown in FIG. 1, the wheelchair 70 further includes a travel control unit 72, although not essential. The wheelchair 70 may further include a drive device such as a motor. The travel control unit 72 controls the speed of the wheelchair 70 and the like by controlling the drive device. When the wheelchair 70 is equipped with the terminal device 20, or when the user 74 of the wheelchair 70 carries the terminal device 20, the travel control unit 72 may acquire information for controlling the traveling of the wheelchair 70 from the terminal device 20 to control the drive unit. The travel control unit 72 may acquire information for controlling the traveling of the wheelchair 70 from the information processing device 10 to control the drive device.

The wheelchair 70 may further include a sensor that detects the undulation information of the road surface of the road 40. The sensor of the wheelchair 70 may output the detected undulation information to the information processing device 10. The sensor of the wheelchair 70 may detect information such as an image of the road surface or a distance to each point on the road surface as information for generating the undulation information, and output the information to the information processing device 10.

The wheelchair 70 may further include a position information acquisition unit that acquires the position information of the wheelchair 70 itself. The position information acquisition unit may be configured to be the same as or similar to the position information acquisition unit of the terminal device 20.

Operation Example of Information Processing System 1

In the information processing system 1, the information processing device 10 determines the travel path 80 to be traveled when the wheelchair 70 crosses the road 40 by operating as described below, for example.

Detection of Wheelchair 70

The control unit 11 of the information processing device 10 detects a wheelchair 70 that crosses the road 40. The control unit 11 may detect the wheelchair 70 located within a predetermined distance from the road 40 or the wheelchair 70 staying within the predetermined distance from the road 40 for a predetermined time or more as the wheelchair 70 that crosses the road 40. The control unit 11 may detect the wheelchair 70 that crosses the road 40 based on, for example, the position information of the wheelchair 70 itself, or the position information of the terminal device 20 mounted on the wheelchair 70 or the terminal device 20 carried by the user 74 of the wheelchair 70. The control unit 11 may detect the wheelchair 70 that crosses the road 40 based on, for example, images obtained by photographing the road 40 and the surroundings of the road 40. The control unit 11 may detect the wheelchair 70 that crosses the road 40 based on, for example, the detection result of the sensor for detecting the presence of the wheelchair 70 on the road 40 and around the road 40.

Acquisition of Undulation Information

The control unit 11 acquires the undulation information of the road surface around the wheelchair 70. The control unit 11 may acquire the undulation information of the road surface in a range that the wheelchair 70 may pass when crossing the road 40. The control unit 11 may acquire the undulation information from the detection unit 14. The control unit 11 may acquire the undulation information from the terminal device 20 or the wheelchair 70.

The control unit 11 may acquire the height of at least a point of a part of the road surface as the undulation information. The control unit 11 may calculate the contour lines defined based on the height of at least the point of the part of the road surface. For example, in FIGS. 2 and 3, the contour lines of the road surface are represented in dashed lines as a first contour line 42a and a second contour line 42b. The height of the point where the first contour line 42a extends may be the same as or different from the height of the point where the second contour line 42b extends. The height of the point where the first contour line 42a extends may be higher than or lower than the height of the point where the second contour line 42b extends. In the present embodiment, the height of the point where the first contour line 42a extends is lower than the height of the point where the second contour line 42b extends.

Determination of Travel Path 80

The control unit 11 determines the travel path 80 when the wheelchair 70 crosses the road 40 based on the undulation information of the road surface. As shown in FIGS. 2 and 3, for example, the control unit 11 may determine a path intersecting the first contour line 42a and the second contour line 42b, which are defined as the undulation information of the road surface of the road 40, as the travel path 80. The control unit 11 may determine a path orthogonal to the first contour line 42a and the second contour line 42b as the travel path 80. The control unit 11 determines a straight path extending in a direction inclined with respect to the direction orthogonal to the road 40 as the travel path 80 of the wheelchair 70 on the road surface having the contour lines illustrated in FIG. 2. The control unit 11 determines a curved path in which the angles intersecting the contour lines are right angles or angles close to right angles as the travel path 80 of the wheelchair 70 on the road surface having the contour lines illustrated in FIG. 3.

The control unit 11 may determine the travel path 80 of the wheelchair 70 also based on the center of gravity position 75 of the wheelchair 70. Specifically, the control unit 11 may determine the travel path 80 of the wheelchair 70 based on the deviation of the center of gravity of the wheelchair 70 in the axle direction. The axle direction of the wheelchair 70 is a direction along a line connecting the center of the left drive wheel 76L and the center of the right drive wheel 76R. The axle direction of the wheelchair 70 corresponds to the X-axis direction in FIGS. 4 and 5. The reference position of the center of gravity of the wheelchair 70 in the axle direction is assumed to be the center of gravity position 75 of the wheelchair 70 when the height of the road surface in contact with the left drive wheel 76L of the wheelchair 70 and the height of the road surface in contact with the right drive wheel 76R are the same. In the example of FIG. 4, the reference position of the center of gravity of the wheelchair 70 in the axle direction is located in the middle between the left drive wheel 76L and the right drive wheel 76R. When the wheelchair 70 is tilted to the left or right, the center of gravity of the wheelchair 70 is deviated from the reference position in the positive or negative direction of the X-axis, that is, in the axle direction. When the center of gravity of the wheelchair 70 is deviated toward the drive wheel 76 of either the left drive wheel 76L or the right drive wheel 76R, or is deviated outward from the right and left drive wheels 76, the possibility of the wheelchair 70 falling to the right or left increases. The control unit 11 may determine the travel path 80 so that when the wheelchair 70 travels along the travel path 80, the deviation of the center of gravity position 75 of the wheelchair 70 in the axle direction is less than the first threshold value. The first threshold value may be, for example, ¼ of the distance between the left drive wheel 76L and the right drive wheel 76R, but is not limited to this, and may be various values. The first threshold value may be various values of ½ or less of the distance between the left drive wheel 76L and the right drive wheel 76R.

By determining the travel path 80 of the wheelchair 70 so that the travel path 80 intersects the contour lines of the road surface of the road 40, the right-left inclination of the wheelchair 70 is reduced. That is, the deviation of the center of gravity position 75 of the wheelchair 70 in the axle direction is reduced. Further, by determining the travel path 80 of the wheelchair 70 based on the center of gravity position 75 of the wheelchair 70, the deviation of the center of gravity position 75 of the wheelchair 70 in the axle direction is reduced. Since the deviation of the center of gravity position 75 of the wheelchair 70 in the axle direction is small, the user 74 of the wheelchair 70 can obtain a sense of stability when the wheelchair 70 is traveling. As a result, the convenience of the traveling of the wheelchair 70 is improved.

The control unit 11 may determine the travel path 80 of the wheelchair 70 based on the deviation of the center of gravity of the wheelchair 70 in the traveling direction. The traveling direction of the wheelchair 70 is orthogonal to the line connecting the center of the left drive wheel 76L and the center of the right drive wheel 76R, and is a direction along the road surface. The traveling direction of the wheelchair 70 corresponds to the Y-axis direction in FIGS. 4 and 5. The reference position of the center of gravity of the wheelchair 70 in the traveling direction is assumed to be the center of gravity position 75 when the height of the road surface in contact with the drive wheel 76 of the wheelchair 70 and the height of the road surface in contact with the caster 78 are the same. When the wheelchair 70 is tilted to the front or rear, the center of gravity of the wheelchair 70 is deviated from the reference position in the positive or negative direction of the Y-axis, that is, in the traveling direction. When the center of gravity of the wheelchair 70 is deviated to the rear of the drive wheels 76 or to the front of the casters 78, the possibility of the wheelchair 70 falling to the front or rear increases. The control unit 11 may determine the travel path 80 so that when the wheelchair 70 travels along the travel path 80, the deviation of the center of gravity position 75 of the wheelchair 70 in the traveling direction is less than the second threshold value. The second threshold value may be, for example, ¼ of the distance between the center of the drive wheels 76 and the center of the casters 78 in the Y-axis direction, but is not limited to this, and may be various values. The second threshold value may be various values of ½ or less of the distance between the center of the drive wheels 76 and the center of the casters 78 in the Y-axis direction.

The control unit 11 may determine the travel path 80 of the wheelchair 70 so that the travel path 80 intersects the contour lines of the road surface of the road 40 and the inclination of the wheelchair 70 in the front-rear direction is reduced when the wheelchair 70 travels along the travel path 80. The control unit 11 may determine the travel path 80 of the wheelchair 70 so that the inclination of the wheelchair 70 in the front-rear direction is reduced when the wheelchair 70 travels along the travel path 80, regardless of the angles between the travel path 80 and the contour lines of the road surface. In this way, the user 74 of the wheelchair 70 can obtain a sense of stability when the wheelchair 70 is traveling. As a result, the convenience of the traveling of the wheelchair 70 is improved.

The control unit 11 may determine the travel path 80 so that the height difference of each point included in the travel path 80 of the wheelchair 70 becomes small. In this way, the wheelchair 70 can easily travel. As a result, the convenience of the traveling of the wheelchair 70 is improved.

The control unit 11 may determine the travel path 80 so that the rate of change in the height of each point included in the travel path 80 becomes small while the wheelchair 70 is traveling. The rate of change in the height of each point included in the travel path 80 corresponds to the gradient of the road surface along the traveling direction of the wheelchair 70. As the gradient of the road surface becomes smaller, the wheelchair 70 becomes easier to travel. As a result, the convenience of the traveling of the wheelchair 70 is improved.

The control unit 11 may determine the travel path 80 so that the difference between the height of the road surface in contact with the left drive wheel 76L of the wheelchair 70 and the height of the road surface in contact with the right drive wheel 76R is small. The difference between the height of the road surface in contact with the left drive wheel 76L of the wheelchair 70 and the height of the road surface in contact with the right drive wheel 76R is also referred to as the height difference between the right and left wheels. By reducing the height difference between the right and left wheels, the user 74 of the wheelchair 70 can obtain a sense of stability when the wheelchair 70 is traveling. As a result, the convenience of the traveling of the wheelchair 70 is improved.

The control unit 11 may determine the travel path 80 so that the change in the height difference between the right and left wheels is small. In this way, swinging of the wheelchair 70 in the right-left direction is reduced. By reducing the swinging in the right-left direction, the user 74 of the wheelchair 70 can obtain a sense of stability when the wheelchair 70 is traveling. As a result, the convenience of the traveling of the wheelchair 70 is improved.

Output of Travel Path 80

When the control unit 11 determines the travel path 80 of the wheelchair 70, the control unit 11 may output the determined travel path 80 from the I/F 12 to the terminal device 20 or the wheelchair 70. The terminal device 20 or the wheelchair 70 may notify the user 74 of the travel path 80. The user 74 may operate and move the wheelchair 70 based on the notified travel path 80. The wheelchair 70 may travel along the travel path 80 by the travel control unit 72 based on the travel path 80 acquired from the information processing device 10.

The control unit 11 may display the determined travel path 80 on the road surface. The control unit 11 may cause the display device 84 to display the determined travel path 80 on the road surface. The control unit 11 may display the determined travel path 80 on the road surface through projection from the wheelchair 70 or the terminal device 20.

The control unit 11 may cause the terminal device 20 to display the travel path 80 so that the user 74 can recognize the travel path 80 of the wheelchair 70, or may cause the display device 84 to display the travel path 80 on the road 40.

Display of Pedestrian Crossing 82

The control unit 11 may cause the display device 84 to display the pedestrian crossing 82 on the road 40 to be crossed by the wheelchair 70. That is, the control unit 11 may control the display device 84 so that the pedestrian crossing 82 is displayed on the road 40 on which the vehicle 60 travels. As illustrated in FIG. 2, the control unit 11 may cause the display device 84 to display the pedestrian crossing 82 on the road surface of the road 40 in the range including the travel path 80 of the wheelchair 70. As illustrated in FIG. 3, the control unit 11 may cause the display device 84 to display the pedestrian crossing 82 along the travel path 80 of the wheelchair 70. Further, the control unit 11 may change the width of the pedestrian crossing 82 so that the wheelchair 70 traveling along the travel path 80 of the wheelchair 70 can travel within the pedestrian crossing 82.

Procedure Example of Information Processing Method

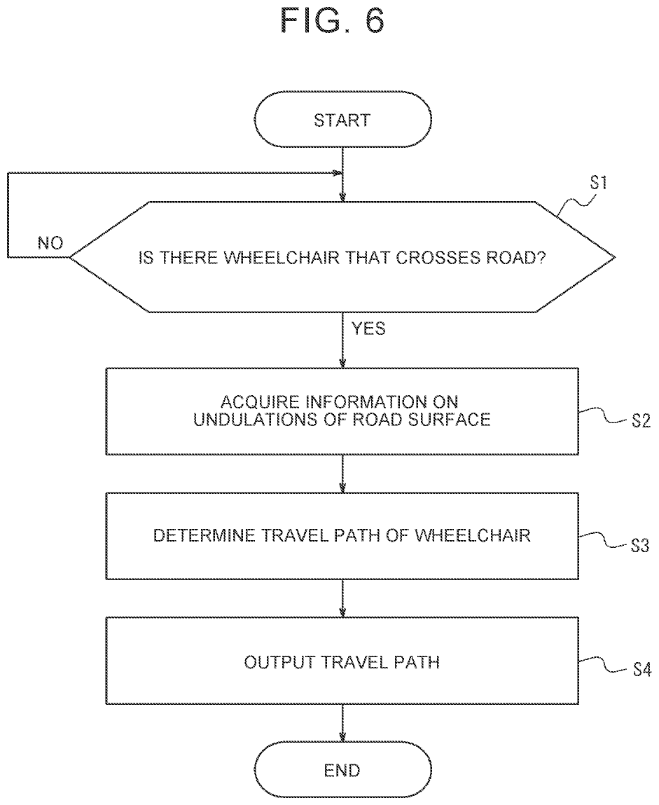

The control unit 11 may execute an information processing method including the procedure of a flowchart illustrated in FIG. 6. The information processing method may be realized as an information processing program to be executed by a processor constituting the control unit 11. The information processing program may be stored in a non-transitory computer-readable medium.

The control unit 11 determines whether there is a wheelchair 70 that crosses the road 40 (step S1). When there is no wheelchair 70 that crosses the road 40 (step S1: NO), the control unit 11 repeats the determination procedure of step S1. When there is a wheelchair 70 that crosses the road 40 (step S1: YES), the control unit 11 acquires information on the undulations of the road surface (step S2).

The control unit 11 determines the travel path 80 when the wheelchair 70 crosses the road 40 based on the information on the undulations of the road surface (step S3). The control unit 11 outputs the determined travel path 80 (step S4). Specifically, the control unit 11 may output the determined travel path 80 to the terminal device 20 or the wheelchair 70. The control unit 11 may cause the display device 84 to display the determined travel path 80 on the road surface. The control unit 11 ends the flowchart of FIG. 6 after executing the procedure of step S4.

### Summary

As described above, the information processing system 1 and the information processing device 10 according to the present embodiment can determine the travel path 80 of the wheelchair 70 that crosses the road 40 based on the information on the undulations of the road surface of the road 40. In this way, it becomes easier for the wheelchair 70 to travel when crossing the road 40. As a result, the convenience of the traveling of the wheelchair 70 is improved.

### OTHER EMBODIMENTS

The information processing system 1 is not limited to the above-described mode, and may be realized in various other modes. Hereinafter, other embodiments will be described.

Travel Path 80 According to Operation of Wheelchair 70

When operating the wheelchair 70, the user 74 of the wheelchair 70 may alternately move the left drive wheel 76L and the right drive wheel 76R with one hand. In this case, the travel path 80 of the wheelchair 70 becomes a finely curved route, that is, a so-called zigzag route. The control unit 11 may determine the travel path 80 of the wheelchair 70 according to the situation in which the user 74 operates the wheelchair 70. For example, the control unit 11 may determine the travel path 80 of the wheelchair 70 so that the user 74 alternately moves the right and left drive wheels 76 of the wheelchair 70 to proceed. The control unit 11 may determine the travel path 80 in consideration of whether to move the left drive wheel 76L or the right drive wheel 76R based on the information on the undulations of the road surface. In this way, the user 74 can easily operate the wheelchair 70. As a result, the convenience of the traveling of the wheelchair 70 is improved.

Although the embodiment according to the present disclosure has been described above based on the drawings and examples, it should be noted that those skilled in the art can make various modifications and alterations thereto based on the present disclosure. It should be noted, therefore, that these modifications and alterations are within the scope of the present disclosure. For example, the functions included in each means, each step, or the like can be rearranged so as not to be logically inconsistent, and a plurality of means, steps, or the like can be combined into one or divided.

What is claimed is:

1. An information processing device comprising a control unit that determines a travel path of a wheelchair that crosses a road, wherein the control unit determines the travel path of the wheelchair based on information on undulations of a road surface of the road.

2. The information processing device according to claim 1, wherein the control unit
acquires a height of at least a point of a part of the road surface of the road as the information on the undulations of the road surface, and
determines the travel path of the wheelchair such that the travel path intersects a contour line that is defined based on the height of the at least the point of the part of the road surface.

3. The information processing device according to claim 2, wherein the control unit determines the travel path of the wheelchair such that the travel path is orthogonal to the contour line.

4. The information processing device according to claim 1, wherein the control unit causes a display device to display the travel path of the wheelchair on the road surface of the road.

5. The information processing device according to claim 1, wherein the control unit causes a display device to display a pedestrian crossing in a range including the travel path of the wheelchair on the road surface of the road.

6. The information processing device according to claim 5, wherein the control unit causes the display device to display the pedestrian crossing along the travel path of the wheelchair.

7. The information processing device according to claim 6, wherein the control unit changes a width of the pedestrian crossing to allow the wheelchair traveling along the travel path of the wheelchair to travel within the pedestrian crossing.

8. The information processing device according to claim 1, wherein the control unit determines the travel path of the wheelchair further based on a position of a center of gravity of the wheelchair.

9. The information processing device according to claim 8, wherein the control unit determines the travel path of the wheelchair based on a deviation of the center of gravity of the wheelchair in an axle direction or in a traveling direction.

10. The information processing device according to claim 1, wherein the control unit determines the travel path of the wheelchair such that a height difference of each point included in the travel path of the wheelchair or a rate of change in a height of each point included in the travel path during traveling of the wheelchair becomes small.

11. The information processing device according to claim 1, wherein the control unit determines the travel path of the wheelchair such that a height difference between right and left wheels of the wheelchair or a change in the height difference between the right and left wheels of the wheelchair during traveling of the wheelchair becomes small.

12. The information processing device according to claim 1, wherein the control unit determines the travel path of the wheelchair such that right and left wheels of the wheelchair are alternately moved to proceed.

13. The information processing device according to claim 1, further comprising a detection unit that detects the information on the undulations of the road surface.

14. The information processing device according to claim 1, wherein the control unit acquires the information on the undulations of the road surface from the wheelchair.

15. The information processing device according to claim 1, wherein:
the information processing device is mounted on the wheelchair; and
the control unit causes the wheelchair to travel along the travel path of the wheelchair.

16. An information processing method for determining a travel path of a wheelchair that crosses a road, comprising determining the travel path of the wheelchair based on information on undulations of a road surface of the road.

17. The information processing method according to claim 16, further comprising:
acquiring a height of at least a point of a part of the road surface of the road as the information on the undulations of the road surface; and
determining the travel path of the wheelchair such that the travel path intersects a contour line that is defined based on the height of the at least the point of the part of the road surface.

18. A terminal device mounted on a wheelchair that crosses a road or carried by a user of the wheelchair, wherein the terminal device acquires from an information processing device a travel path of the wheelchair that is determined by the information processing device based on information on undulations of a road surface of the road.

19. The terminal device according to claim 18, comprising a detection unit that detects the information on the undulations of the road surface and an interface that outputs the information on the undulations of the road surface to the information processing device.

20. The terminal device according to claim 18, wherein the terminal device controls traveling of the wheelchair based on the travel path of the wheelchair.
